(19) United States
(12) Patent Application Publication
(10) Pub. No.: US 2018/0205635 A1
(43) Pub. Date: Jul. 19, 2018

(54) FILE ACCESS PATH SELECTION METHOD FOR TORUS NETWORK-BASED DISTRIBUTED FILE SYSTEM AND APPARATUS FOR THE SAME

(71) Applicant: ELECTRONICS AND TELECOMMUNICATIONS RESEARCH, INSTITUTE (KR)

(72) Inventors: Young-Chang KIM, Daejeon (KR); Young-Kyun KIM, Daejeon (KR); Hong-Yeon KIM, Daejeon (KR); Jeong-Sook PARK, Daejeon (KR); Joon-Young PARK, Daejeon (KR)

(21) Appl. No.: 15/684,267

(22) Filed: Aug. 23, 2017

(30) Foreign Application Priority Data
Jan. 18, 2017 (KR) 10-2017-0008514

(51) Int. Cl. H04L 12/733; H04L 29/08; G06F 17/30

(52) U.S. Cl. CPC H04L 45/122; H04L 67/1097; H04L 67/42; G06F 17/30106; G06F 17/30203

(57) ABSTRACT

Disclosed herein are a torus network-based file access path selection method for a distributed file system and an apparatus for the method. The file access path selection method includes acquiring, by a client, layout information about a file desired to be accessed, searching multiple data servers for an object data server based on the layout information, and determining a file access pattern based on a file access location and a size of the file, and setting any one of a shortest path for accessing the object data server and a secondary path having a hop count increased by one hop from that of the shortest path, as an access path to the object data server in consideration of the file access pattern and a bandwidth utilization rate for a network address located on the shortest path.

### CROSS REFERENCE TO RELATED APPLICATION

This application claims the benefit of Korean Patent Application No. 10-2017-0008514, filed Jan. 18, 2017, which is hereby incorporated by reference in its entirety into this application.

### BACKGROUND OF THE INVENTION

### 1. Technical Field

The present invention relates generally to a file access path selection method for a torus network-based distributed file system and, more particularly, to technology that is capable of providing an access path most suitable for a client depending on an access pattern and a bandwidth because access paths to a data server that stores a file desired to be accessed by the client may be present in various forms.

### 2. Description of the Related Art

In order to provide Exabyte-scale storage, a torus network-based distributed file system has been proposed. In the distributed file system, data servers are connected over a three-dimensional (3D) torus network, and a switch is used only for a connection between data servers located in a first plane and a client.

Here, in order for the client to access data servers located in a second plane or higher-level plane that is not directly connected to the switch, the client and all data servers individually perform a selection function, thus enabling accessible paths to be routed between the client and all data servers. That is, the client performs file input/output along the path routed to access data servers located on the second plane or a higher-level plane.

Generally, path selection between data servers is performed to set up the shortest path having a minimum hop count. In a torus network-based distributed file system, the client is connected to data servers on the first plane through a switch, and thus there is only one shortest path between the client and a specific data server. Therefore, when multiple clients desire to access the same data server, they access the data server through the same shortest path, and thus there is a disadvantage in that the maximum performance for file input/output is limited to the maximum bandwidth of a single path.

U.S. Patent Application Publication No. 2016/0065449 entitled “Bandwidth-weighted equal cost multi-path routing” discloses a method that is capable of transmitting network traffic using multiple paths when there are multiple equal-cost paths between a source node and a destination node. However, this method is applied only to equal-cost paths, that is, paths having the same hop count, among the shortest paths present between the source node and the destination node, thus not being completely capable of overcoming the above disadvantage.

In order to solve this limitation, there is required a method for improving maximum file input/output performance for a single data server using additional paths as well as the shortest path. In connection with this, U.S. Patent Application Publication No. US2016/0065449 (Date of Publication: Mar. 3, 2016) discloses a technology related to “Bandwidth-Weighted Equal Cost Multi-Path Routing.”

### SUMMARY OF THE INVENTION

Accordingly, the present invention has been made keeping in mind the above problems occurring in the prior art, and an object of the present invention is to solve a disadvantage in which file input/output performance is limited to the maximum bandwidth of a single path by providing an additional path similar to the shortest path depending on the case where access to a file is requested.

Another object of the present invention is to reduce bandwidth usage rate of the shortest path and improve the overall file input/output performance by providing an additional path other than the shortest path in the case of a sequential access pattern that does not greatly influence the delay time of traffic.

A further object of the present invention is to provide an idea making it possible to efficiently perform topology monitoring of a file system while providing the most effective data transmission/reception performance by selecting the shortest path.

In accordance with an aspect of the present invention to accomplish the above objects, there is provided a file access path selection method for a distributed file system, the method being performed using a file access path selection apparatus for the distributed file system, the file access path selection method including acquiring, by a client, layout information about a file desired to be accessed, from a metadata server; searching, by the client, multiple data servers for an object data server in which the file is stored, based on communication with a management server and the layout information, and determining, by the client, a file access pattern based on a file access location and a size of the file; and setting, by the client, any one of a shortest path for accessing the object data server and a secondary path having a hop count increased by one hop from that of the shortest path, as an access path to the object data server in consideration of the file access pattern and a bandwidth utilization rate for a network address located on the shortest path.

Setting any one of the shortest path and the secondary path as the access path to the object data server may include when the file access pattern indicates a sequential access pattern, checking a bandwidth utilization rate for a first network address of the object data server located on the shortest path based on the layout information; checking respective bandwidth utilization rates for multiple candidate network addresses of the object data server, usable as the secondary path, when the bandwidth utilization rate for the first network address is equal to or greater than a threshold; and selecting the access path depending on which one of the first network address and the multiple candidate network addresses has a lowest bandwidth utilization rate.

Selecting the access path may be configured to, when the bandwidth utilization rate for the first network address is lowest, set the shortest path as the access path, and, when a bandwidth utilization rate for any one of the multiple candidate network addresses is lowest, set a secondary path that uses the one candidate network address as the access path.

Setting any one of the shortest path and the secondary path as the access path to the object data server may be configured to, when the file access pattern indicates a random-access pattern, set the shortest path as the access path to the object data server.

The layout information may include a data server ID of the object data server that corresponds to location coordinates of the object data server on a torus network including the multiple data servers, and the client may be configured to periodically acquire, from the management server, data server information corresponding to at least one of multiple network addresses that are allocated to the object data server depending on a structure of the torus network based on the data server ID, and bandwidth utilization rates for the multiple network addresses at a preset interval.

Selecting the access path may include selecting any one data server, which is located on the secondary path and corresponds to a first plane in the structure of the torus network, from among the multiple data servers, as a relay server; and calculating and acquiring location coordinates of the relay server based on the location coordinates of the object data server, and selecting the access path to include the location coordinates of the relay server.

The first network address may correspond to a front network address allocated to a forward direction of the object data server.

The file access path selection method may further include, when selecting of the access path is completed and an input/output processing request for the file is received from the client, determining, by the object data server, whether target data server information included in the input/output processing request matches the object data server; and if the target data server information does not match the object data server, re-selecting the access path so that the client is capable of connecting to a target data server matching the target data server information.

The file access path selection method may further include, if it is determined that the target data server information matches the object data server, updating a bandwidth utilization rate for a network address corresponding to the access path depending on an amount of bandwidth used in response to the input/output processing request.

Analyzing the file access pattern may be configured to analyze the file access pattern based on at least one of an offset and the size of the file, which are included in an access request for the file, during a preset determination time.

In accordance with another aspect of the present invention to accomplish the above objects, there is provided a file access path selection apparatus for a distributed file system, including multiple data servers connected to each other in a structure of a torus network and each configured to store at least one file; a metadata server configured to store layout information about the at least one file; a management server configured to store data server information about the multiple data servers and manage the multiple data servers; and at least one client configured to search the multiple data servers for an object data server in which an object file desired to be accessed is stored, based on the layout information, and to set any one of a shortest path to the object data server and a secondary path having a hop count increased by one hop from that of the shortest path, as an access path to the object data server, in consideration of a file access pattern for the object file and a bandwidth utilization rate for a network address located on the shortest path.

The client may be configured to, when the file access pattern indicates a sequential access pattern, check a bandwidth utilization rate for a first network address of the object data server located on the shortest path based on the layout information, check respective bandwidth utilization rates for multiple candidate network addresses of the object data server, usable as the secondary path, when the bandwidth utilization rate for the first network address is equal to or greater than a threshold, and route the access path depending on which one of the first network address and the multiple candidate network addresses has a lowest bandwidth utilization rate.

The client may be configured to, when the bandwidth utilization rate for the first network address is lowest, set the shortest path as the access path, and, when a bandwidth utilization rate for any one of the multiple candidate network addresses is lowest, set a secondary path that uses the one candidate network address as the access path.

The client may be configured to, when the file access pattern indicates a random-access pattern, set the shortest path as the access path.

The layout information may include a data server ID of the object data server that corresponds to location coordinates of the object data server on the torus network, and the client may be configured to periodically acquire, from the management server, data server information corresponding to at least one of multiple network addresses that are allocated to the object data server depending on a structure of the torus network based on the data server ID, and bandwidth utilization rates for the multiple network addresses at a preset interval.

The client may be configured to select any one data server, which is located on the secondary path and corresponds to a first plane in the structure of the torus network, from among the multiple data servers, as a relay server, calculate and acquire location coordinates of the relay server based on the location coordinates of the object data server, and route the access path to include the location coordinates of the relay server.

The first network address may correspond to a front network address allocated to a forward direction of the object data server.

The client may be configured to, when selecting of the access path is completed and an input/output processing request for the object file is received from the client, determine whether target data server information included in the input/output processing request matches the object data server.

The client may be configured to, if the target data server information does not match the object data server, re-route the access path so that the client is capable of connecting to a target data server matching the target data server information.

The client may be configured to, if it is determined that the target data server information matches the object data server, update a bandwidth utilization rate for a network address corresponding to the access path depending on an amount of bandwidth used in response to the input/output processing request.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a diagram illustrating a file access path selection system for a distributed file system according to an embodiment of the present invention;

FIG. 2 is an operation flowchart illustrating a file access path selection method for 6a distributed file system according to an embodiment of the present invention;

FIG. 3 is a diagram illustrating an example of data server information according to the present invention;

FIG. 4 is a diagram illustrating an embodiment in which the access path of a client is routed according to the present invention;

FIG. 5 is an operation flowchart illustrating in detail a procedure in which the input/output of a file is processed using the file access path selection method according to an embodiment of the present invention; and

FIG. 6 is an operation flowchart illustrating a method for processing a file input/output request from a client according to an embodiment of the present invention.

FIG. 7 is an embodiment of the present invention implemented in a computer system.

### DESCRIPTION OF THE PREFERRED EMBODIMENTS

The present invention will be described in detail below with reference to the accompanying drawings. Repeated descriptions and descriptions of known functions and configurations which have been deemed to make the gist of the present invention unnecessarily obscure will be omitted below. The embodiments of the present invention are intended to fully describe the present invention to a person having ordinary knowledge in the art to which the present invention pertains. Accordingly, the shapes, sizes, etc. of components in the drawings may be exaggerated to make the description clearer.

Hereinafter, preferred embodiments of the present invention will be described in detail with reference to the attached drawings.

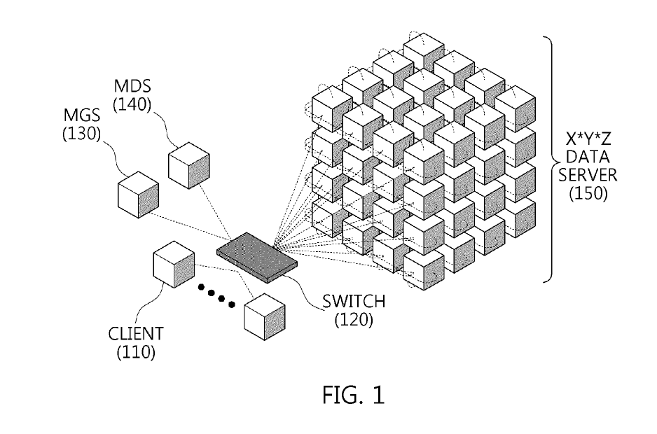

FIG. 1 is a diagram illustrating a file access path selection system for a distributed file system according to an embodiment of the present invention.

Referring to FIG. 1, the file access path selection system for a distributed file system according to the embodiment of the present invention includes clients 110, a switch 120, a management server (MGS) 130, a metadata server (MDS) 140, and multiple data servers 150.

Each client 110 may be an entity that accesses the distributed file system through the switch 120 and performs a file operation.

The management server 130 may be a server that manages the multiple data servers 150.

Here, in the management server 130, multiple management servers may be present as active-standby components to provide high availability.

In this case, as shown in FIG. 1, the management server 130 may be directly connected to the switch 120 rather than to a torus network to make fast access to the client 110, and may then be independently present. The management server 130 may also be present in a first plane of the torus network depending on the configuration of the distributed file system.

The metadata server 140 may literally mean an actual server for storing metadata.

Here, the metadata server 140 may be composed of multiple servers, and may distribute the metadata to the multiple servers and may then store and manage the metadata in the servers.

In this case, similarly to the management server 130, the metadata server 140 may also be directly connected to the switch 120, and may then be independently present, or may be present in any plane of the torus network depending on the configuration of the distributed file system.

The multiple data servers 150 may be servers that store actual data or files.

The multiple data servers 150 may be connected to the torus network without a separate switch therebetween.

Here, data servers located in the first plane may be directly connected to the switch 120, thus making a connection to the client 110.

The client 110, the management server 130, the metadata server 140, etc. perform a selection function to make a network connection to data servers located in a second or higher-level plane which is not connected to the switch 120, so that accessible paths may be routed between the client and the date servers.

In the file access path selection system for the distributed file system, the location information of the metadata server 140 or the multiple data servers 150 connected based on the torus network may be represented by coordinate values composed of a plane, rows, and columns. Such coordinate values may be used for transmission/reception of information to/from the client 110. Further, when this method is utilized, performance that enables information to be transmitted/received within the shortest time may be provided, and topology monitoring for the file system may be efficiently performed.

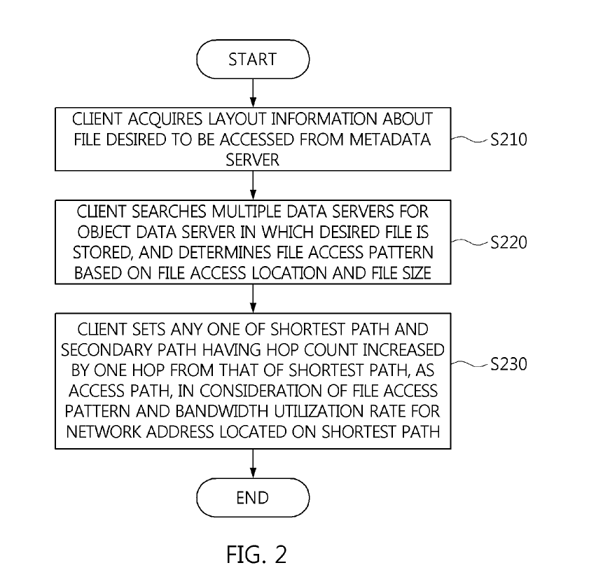

FIG. 2 is an operation flowchart illustrating a file access path selection method for a distributed file system according to an embodiment of the present invention.

Referring to FIG. 2, in the file access path selection method for the distributed file system according to the embodiment of the present invention, the client acquires layout information about a file desired to be accessed from the metadata server at step S210.

Here, the layout information may include the data server ID of an object data server in which a file desired to be accessed by the client is stored on a torus network composed of multiple data servers, wherein the data server ID corresponds to the location coordinates of the object data server.

In this case, the client may periodically acquire data server information corresponding to at least one of multiple network addresses, which are allocated to the object data server depending on the structure of the torus network based on data server ID, and bandwidth utilization rates for respective multiple network addresses, from the management server at a preset interval.

Here, the client may be connected to the metadata server or the management server through the switch and may then perform communication.

Further, in the file access path selection method for the distributed file system according to the embodiment of the present invention, the client searches the multiple data servers for an object data server in which the desired file is stored, based on communication with the management server and the layout information, and determines a file access pattern for the file based on a file access location and the size of the file at step S220.

Here, the file access pattern may be analyzed based on at least one of an offset and the size of the file, which are included in an access request for the file, during a preset determination time.

In this case, a sequential access pattern denotes a scheme for accessing files present on disk as if tape were reproduced, and may mean that files are sequentially accessed in the order in which records are stored. Such sequential access may be the most typical access scheme, and editors or compilers may generally access files using this scheme.

Further, a random-access or direct-access pattern denotes a scheme in which a disk is capable of directly accessing any block in an arbitrary file. For example, the random access or direct access pattern denotes the scheme in which the disk is capable of reading No. 10 file block, reading No. 24 file block, and then writing No. 40 file block. Therefore, for the random-access pattern, each file may be regarded as a series of blocks or records having numbers.

Furthermore, in the file access path selection method for the distributed file system according to the embodiment of the present invention, the client sets any one of the shortest path for accessing the object data server and a secondary path having a hop count increased by one hop from that of the shortest path, as an access path to the object data server, in consideration of the file access pattern and the bandwidth utilization rate for a network address located on the shortest path at step S230.

Here, when the file access pattern indicates a sequential access pattern, the bandwidth utilization rate for a first network address of the object data server located on the shortest path may be checked based on the layout information.

The first network address may correspond to a front network address (IP address) IP_{front} allocated to the forward direction of the object data server.

In this case, when the bandwidth utilization rate BW_{front} of the first network address is equal to or greater than a preset threshold, respective bandwidth utilization rates for multiple candidate network addresses of the object data server, which are usable as a secondary path, may be checked.

In this case, the preset threshold may correspond to a predetermined percentage of the maximum bandwidth of the first network address. For example, assuming that the preset threshold is set to a value corresponding to 90% of the maximum bandwidth of the first network address, if the bandwidth utilization rate for the first network address is 90% or more, respective bandwidth utilization rates for multiple candidate network addresses may be checked.

Here, multiple candidate network addresses of the object data server, usable as the secondary path, may mean the network addresses of the object data server that are located on all paths having a hop count increased by one hop from that of the shortest path. For example, among the network addresses allocated to the object data server, IP_{front}, corresponding to the forward direction, is the shortest path, and IP_{left}, IP_{right}, IPᵤₚ, and IP_{down} may correspond to multiple candidate network addresses.

The access path may be routed depending on which network address, among the first network address and multiple candidate network addresses, has the lowest bandwidth utilization rate.

Here, when the bandwidth utilization rate for the first network address is the lowest, the shortest path is set as the access path. When the bandwidth utilization rate for any one of the multiple candidate network addresses is the lowest, a secondary path that uses the one candidate network address may be set as the access path.

That is, when the bandwidth utilization rate for the first network address is the lowest, the bandwidth utilization rates of the multiple candidate network addresses are already high, and thus the client may access the object data server using the shortest path, rather than using a path having a hop count increased by one hop.

Here, among the multiple data servers, any one data server that is located on the secondary path and corresponds to the first plane in the structure of the torus network may be selected as a relay server.

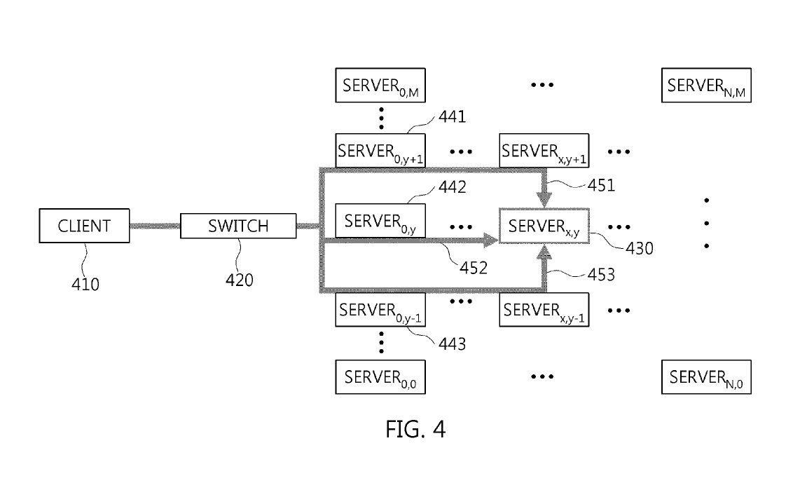

At this time, the location coordinates of the relay server may be calculated and acquired based on the location coordinates of the object data server, and an access path may be routed to include the location coordinates of the relay server. Here, a procedure for calculating the location coordinates of the relay server will be described in detail later with reference to FIG. 4.

When the secondary path including the relay server is set as the access path in this way, the client may set up a network connection to the network address IP_{front} of the relay server through the switch, and may then access the object data server.

Further, when the file access pattern is a random-access pattern, the shortest path may be set as the access path to the object data server.

That is, when the file access pattern indicates a random-access pattern, the client may access the object data server using the first network address of the object data server located on the shortest path to the object data server.

Thereafter, the client may transmit a read or write request to the object data server, and may receive results responding to the request from the object data server.

Further, although not shown in FIG. 2, in the file access path selection method for the distributed file system according to the embodiment of the present invention, if the selecting of the access path has been completed and an input/output processing request for a file is received from the client, the object data server may determine whether target data server information contained in the input/output processing request matches the object data server.

Here, when the target data server information matches the object data server, the bandwidth utilization rate for the network address corresponding to the access path may be updated depending on the amount of bandwidth used in response to the input/output processing request.

Although not shown in FIG. 2, in the file access path selection method for the distributed file system according to the embodiment of the present invention, if the target data server information does not match the object data server, the access path may be re-routed so that the client can be connected to a target data server that matches the target data server information.

Further, although not shown in FIG. 2, the file access path selection method for the distributed file system according to the embodiment of the present invention may store various types of information generated during the above-described procedure for selecting the file access path.

By using the file access path selection method for the distributed file system, the present invention may solve a disadvantage in which file input/output performance is limited to the maximum bandwidth of a single path by providing an additional path similar to the shortest path depending on the case where access to a file is requested.

Further, the present invention may reduce bandwidth usage rate of the shortest path and improve the overall file input/output performance by providing an additional path other than the shortest path in the case of a sequential access pattern that does not greatly influence the delay time of traffic.

Furthermore, the present invention may provide an idea making it possible to efficiently perform topology monitoring of a file system while providing the most effective data transmission/reception performance by selecting the shortest path.

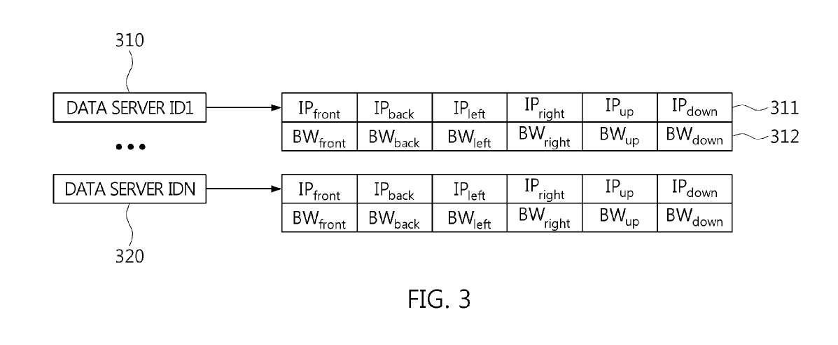

FIG. 3 is a diagram illustrating an example of data server information according to the present invention.

Referring to FIG. 3, a client according to the present invention may acquire volume information or data server information desired to be used by accessing the management server through a mount operation.

Here, the data server information may contain data server IDs 310 and 320, the network addresses 311 of data servers, and the bandwidth utilization rates 312 of the network addresses. Here, the data server information may contain various types of information about the data servers, in addition to the above-described data server IDs, network addresses, and bandwidth utilization rates.

The data server IDs 310 and 320 may contain location coordinates (x, y, z) which indicate the location information of data servers on the torus network. That is, when the data server IDs 310 and 320 are used, the location information of the corresponding data servers may be calculated based on the location coordinates, whereas when the location information is used, the data server IDs of the corresponding data servers may be calculated and acquired.

The network addresses 311 of each data server may correspond to six network addresses connected to the corresponding data server in the structure of the 3D torus network. Therefore, the network addresses may indicate network addresses for links connected in forward, backward, leftward, rightward, upward and downward directions for each data server ID 310 or 320.

The bandwidth utilization rates 312 of the network addresses may indicate bandwidth utilization rates for respective network addresses of each data server. Here, the bandwidth utilization rates 312 for respective network addresses may mean the sizes of data transmitted or received to or from respective network addresses of the corresponding data server during a preset period, that is, file input/output performance per second.

Here, the data server information such as that shown in FIG. 3 may be present for all data servers included in the torus network, and may be stored and managed in the management server.

Therefore, the client may acquire the data server ID of a data server which stores a file desired to be accessed through the metadata server, and may acquire data server information from the management server based on the acquired data server ID.

FIG. 4 is a diagram illustrating an embodiment in which the access path of a client is routed according to the present invention.

Referring to FIG. 4, the procedure for selecting the access path of the client according to the present invention will be described using a 2D torus network composed of N*M data servers by way of example.

First, it may be assumed that the coordinates of a data server desired to be accessed for file input/output by a client 410 shown in FIG. 4 are (x, y). Here, an object data server 430 may correspond to Server_{x,y}, and the shortest path to the object data server 430 may correspond to path 452.

Here, when the access path selection method according to the present invention is not used, multiple clients for accessing the object data server 430 desire to perform file input/output using only the path 452, and thus the maximum bandwidth of the path 452 may be the upper limit of the maximum input/output performance.

However, when the access path selection method according to the present invention is used, a bandwidth utilization rate BW_{front} for the network address of the object data server 430 corresponding to the path 452 is checked. When the checked bandwidth utilization rate is equal to or greater than a preset threshold BW_{threshold}, a secondary path may be provided such that a path 451 and a path 453, having a hop count increased by one hop from that of the path 452 that is the shortest path, are used.

That is, in a congested situation in which the bandwidth utilization rate for the network address corresponding to the shortest path is already equal to or greater than a predetermined percentage of the maximum bandwidth, it may be more efficient to provide a secondary path, which is relatively uncongested and to which many hop counts are not added, than to provide a path so that file input/output is continuously performed along the shortest path.

In this case, the respective bandwidth utilization rates BWᵤₚ and BM_{down} of the path 451 and the path 453 having a possibility of being provided as the secondary path are checked. Of the paths, the path having the lower bandwidth utilization rate may be selected as the secondary path and may be provided as the access path of the client 410.

Further, as the secondary path is selected, any one of multiple data servers connected to the switch 420 based on the location coordinates of the object data server 430 may be selected as a relay server.

For example, when the path 451 is selected as the secondary path, Server_{0,y+1}, which is located on the secondary path and is connected to the switch 420, may be selected as the relay server, and the data server ID of Server_{0, y+1} may be acquired by calculating the location coordinates (0, y+1) of the relay server based on the location coordinates (x, y) of the object data server 430.

By providing the access path using this method, the maximum input/output performance of the object data server 430 is not limited to the maximum bandwidth of the path 452 that is the shortest path, and may be improved to correspond to the sum of the maximum bandwidths of the three paths 451, 452, and 453.

In this case, in FIG. 4, as the network structure is the 2D network structure, the possibility of the path 451 and the path 453 being the secondary path has been presented. However, when the network structure is based on the 3D torus network, the secondary path may also be provided using network addresses allocated to rightward, leftward, upward, and downward directions of the object data server, other than the backward direction thereof.

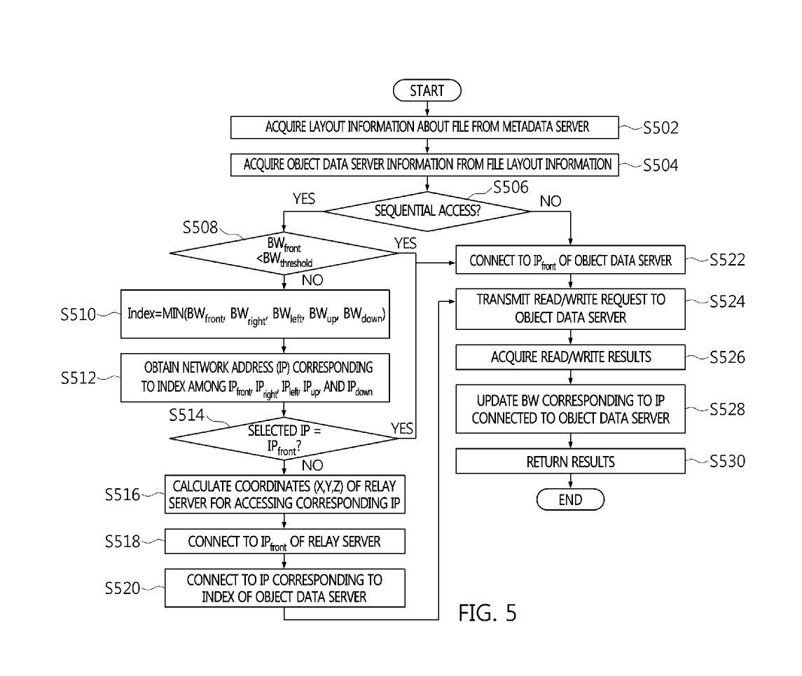

FIG. 5 is an operation flowchart illustrating in detail a procedure in which the input/output of a file is processed using the file access path selection method according to an embodiment of the present invention.

Referring to FIG. 5, the procedure in which the input/output of a file is processed using the file access path selection method according to the embodiment of the present invention acquires layout information about a file from the metadata server at step S502.

Next, information about an object data server is acquired from the layout information about the file at step S504, and it is determined whether a file access pattern for the file indicates a sequential access pattern by analyzing the file access pattern based on the acquired information at step S506.

If it is determined at step S506 that the file access pattern does not indicate a sequential access pattern, it is determined to indicate a random-access pattern, and the client is connected through IP front, front, which is the first network address of the object data server, at step S522.

Thereafter, when the client transmits a read/write request for the file to the object data server at step S524, the object data server processes the request, and then the client acquires results responding to the read/write request at step S526.

Next, the bandwidth utilization rate for the network address connected to the object data server is updated at step S528, and file read/write results are returned at step S530.

Here, since the client is connected through the shortest path, the network address IP_{front} may be updated with BW_{front}, corresponding to the bandwidth utilization rate.

Further, if it is determined at step S506 that the file access pattern indicates the sequential access pattern, it is determined whether the amount of bandwidth BW_{front} used by the first network address corresponding to the shortest path is less than a preset threshold BW_{threshold} at step S508.

If it is determined at step S508 that Bw_{front} is less than the preset threshold BW_{threshold}, the client is connected through IP front, front, which is the first network address of the data server, depending on step S522, and thereafter the process may be performed depending on steps S524 to S530.

Further, if it is determined at step S508 that BW_{front} is not less than BW_{threshold}, an index corresponding to a minimum value is selected from among BW_{front} indicating the bandwidth utilization rate for the first network address, and BW_{right}, BW_{left}, BWᵤₚ, and BW_{down}, which indicate bandwidth utilization rates respectively corresponding to network addresses (IP addresses) IP_{right}, IP_{left}, IPᵤₚ, and IP_{down} of the object data server, usable as the secondary path, at step S510.

Thereafter, any one network address corresponding to the index is selected from among IP_{front}, IP_{right}, IP_{left}, IPᵤₚ, and IP_{down} and is then obtained at step S512. It is determined that the selected one network address is an IP_{front}, which is the first network address, at step S514.

If it is determined at step S514 that the selected one network address is IP_{front}, the client is connected through IP front, front, which is the first network address of the data server, depending on step S522, and thereafter the process may be performed depending on steps S524 to S530.

Further, if it is determined at step S514 that the selected one network address is not IP_{front}, a relay server for accessing the selected one network address may be selected, and the location coordinates of the relay server are calculated at step S516.

Thereafter, the data server ID of the relay server is acquired based on the location coordinates of the relay server, and the client is connected to the IP_{front} of the relay server based on the switch at step S518, and is then connected to a network address corresponding to the index of the object data server at step S520.

Then, when the client transmits a read/write request for the file to the object data server at step S524, the object data server processes the request, and the client acquires results responding to the read/write request at step S526.

Then, the bandwidth utilization rate for the network address connected to the object data server is updated at step S528, and file read/write results are returned at step S530.

However, in this case, since the client is connected to the secondary path based on the network address corresponding to the index other than the shortest path, the bandwidth utilization rate for an IP address corresponding to the index, among IP_{right}, IP_{left}, IPᵤₚ, and IP_{down}, may be updated. That is, any one of BW_{right}, BW_{left}, BWᵤₚ, and BW_{down} may be updated.

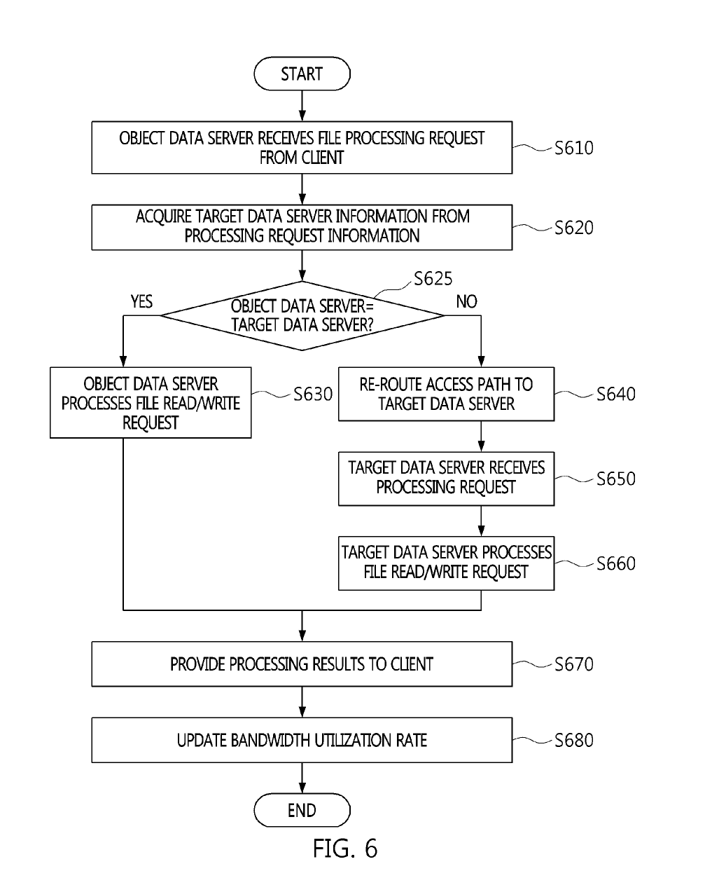

FIG. 6 is an operation flowchart illustrating a method for processing a file input/output processing request from a client according to an embodiment of the present invention.

Referring to FIG. 6, in the method for processing a file input/output processing request from the client according to an embodiment of the present invention, when an object data server receives a file input/output processing request from the client at step S610, information about a target data server from which the client has requested file input/output processing is acquired from file input/output processing request information at step S620.

Thereafter, the object data server to which the client is currently connected determines whether the object data server matches the target data server at step S625.

If it is determined at step S625 that the object data server matches the target data server, the object data server processes the file input/output processing request corresponding to a file read/write operation at step S630.

Thereafter, the object data server provides the results of processing to the client at step S670, and thereafter updates a bandwidth utilization rate corresponding to the path accessed by the client at step S680.

If it is determined at step S625 that the object data server does not match the target data server, the client re-routes an access path so that the client is connected to a data server corresponding to the target data server at step S640.

Next, the data server corresponding to the target data server receives the file input/output processing request from the client at step S650, and processes the file input/output processing request corresponding to the file read/write operation at step S660.

Thereafter, the data server corresponding to the target data server provides the results of processing to the client at step S670, and then updates a bandwidth utilization rate corresponding to the path accessed by the client at step S680.

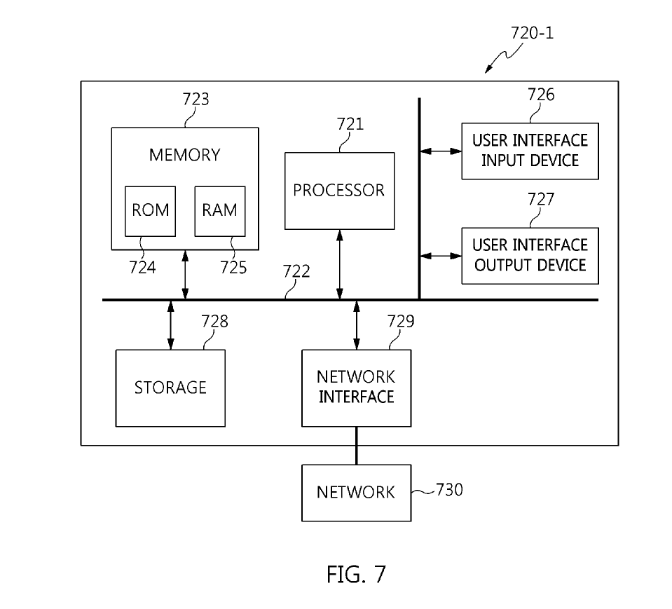

An embodiment of the present invention may be implemented in a computer system, e.g., as a computer readable medium. As shown in in FIG. 7, a computer system 720-1 may include one or more of a processor 721, a memory 723, a user interface input device 726, a user interface output device 727, and a storage 728, each of which communicates through a bus 722. The computer system 720-1 may also include a network interface 729 that is coupled to a network 730. The processor 721 may be a central processing unit (CPU) or a semiconductor device that executes processing instructions stored in the memory 723 and/or the storage 728. The memory 723 and the storage 728 may include various forms of volatile or non-volatile storage media. For example, the memory may include a read-only memory (ROM) 724 and a random access memory (RAM) 725.

Accordingly, an embodiment of the invention may be implemented as a computer implemented method or as a non-transitory computer readable medium with computer executable instructions stored thereon. In an embodiment, when executed by the processor, the computer readable instructions may perform a method according to at least one aspect of the invention.

In accordance with the present invention, it is possible to solve a disadvantage in which file input/output performance is limited to the maximum bandwidth of a single path by providing an additional path similar to the shortest path depending on the case where access to a file is requested.

Further, the present invention may reduce bandwidth usage rate of the shortest path and improve the overall file input/output performance by providing an additional path other than the shortest path in the case of a sequential access pattern that does not greatly influence the delay time of traffic.

Furthermore, the present invention may provide an idea making it possible to efficiently perform topology monitoring of a file system while providing the most effective data transmission/reception performance by selecting the shortest path.

As described above, in the torus network-based file access path selection method for a distributed file system and the apparatus for the method according to the present invention, the configurations and schemes in the above-described embodiments are not limitedly applied, and some or all of the above embodiments can be selectively combined and configured so that various modifications are possible.

What is claimed is:

1. A file access path selection method for a distributed file system, the method being performed using a file access path selection apparatus for the distributed file system, the file access path selection method comprising:
acquiring, by a client, layout information about a file desired to be accessed, from a metadata server;
searching, by the client, multiple data servers for an object data server in which the file is stored, based on communication with a management server and the layout information, and determining, by the client, a file access pattern based on a file access location and a size of the file; and
setting, by the client, any one of a shortest path for accessing the object data server and a secondary path having a hop count increased by one hop from that of the shortest path, as an access path to the object data server in consideration of the file access pattern and a bandwidth utilization rate for a network address located on the shortest path.

2. The file access path selection method of claim 1, wherein setting any one of the shortest path and the secondary path as the access path to the object data server comprises:
when the file access pattern indicates a sequential access pattern, checking a bandwidth utilization rate for a first network address of the object data server located on the shortest path based on the layout information;
checking respective bandwidth utilization rates for multiple candidate network addresses of the object data server, usable as the secondary path, when the bandwidth utilization rate for the first network address is equal to or greater than a threshold; and
selecting the access path depending on which one of the first network address and the multiple candidate network addresses has a lowest bandwidth utilization rate.

3. The file access path selection method of claim 2, wherein selecting the access path is configured to, when the bandwidth utilization rate for the first network address is lowest, set the shortest path as the access path, and, when a bandwidth utilization rate for any one of the multiple candidate network addresses is lowest, set a secondary path that uses the one candidate network address as the access path.

4. The file access path selection method of claim 1, wherein setting any one of the shortest path and the secondary path as the access path to the object data server is configured to, when the file access pattern indicates a random-access pattern, set the shortest path as the access path to the object data server.

5. The file access path selection method of claim 3, wherein:
the layout information includes a data server ID of the object data server that corresponds to location coordinates of the object data server on a torus network including the multiple data servers, and
the client is configured to periodically acquire, from the management server, data server information corresponding to at least one of multiple network addresses that are allocated to the object data server depending on a structure of the torus network based on the data server ID, and bandwidth utilization rates for the multiple network addresses at a preset interval.

6. The file access path selection method of claim 5, wherein selecting the access path comprises:
selecting any one data server, which is located on the secondary path and corresponds to a first plane in the structure of the torus network, from among the multiple data servers, as a relay server; and
calculating and acquiring location coordinates of the relay server based on the location coordinates of the object data server, and selecting the access path to include the location coordinates of the relay server.

7. The file access path selection method of claim 2, wherein the first network address corresponds to a front network address allocated to a forward direction of the object data server.

8. The file access path selection method of claim 2, further comprising:
when selecting of the access path is completed and an input/output processing request for the file is received from the client, determining, by the object data server, whether target data server information included in the input/output processing request matches the object data server; and
if the target data server information does not match the object data server, re-selecting the access path so that the client is capable of connecting to a target data server matching the target data server information.

9. The file access path selection method of claim 8, further comprising, if it is determined that the target data server information matches the object data server, updating a bandwidth utilization rate for a network address corresponding to the access path depending on an amount of bandwidth used in response to the input/output processing request.

10. The file access path selection method of claim 1, wherein analyzing the file access pattern is configured to analyze the file access pattern based on at least one of an offset and the size of the file, which are included in an access request for the file, during a preset determination time.

11. A file access path selection apparatus for a distributed file system, comprising:
multiple data servers connected to each other in a structure of a torus network and each configured to store at least one file;
a metadata server configured to store layout information about the at least one file;
a management server configured to store data server information about the multiple data servers and manage the multiple data servers; and
at least one client configured to search the multiple data servers for an object data server in which an object file desired to be accessed is stored, based on the layout information, and to set any one of a shortest path to the object data server and a secondary path having a hop count increased by one hop from that of the shortest path, as an access path to the object data server, in consideration of a file access pattern for the object file and a bandwidth utilization rate for a network address located on the shortest path.

12. The file access path selection apparatus of claim 11, wherein the client is configured to:
when the file access pattern indicates a sequential access pattern, check a bandwidth utilization rate for a first network address of the object data server located on the shortest path based on the layout information,
check respective bandwidth utilization rates for multiple candidate network addresses of the object data server, usable as the secondary path, when the bandwidth utilization rate for the first network address is equal to or greater than a threshold, and
route the access path depending on which one of the first network address and the multiple candidate network addresses has a lowest bandwidth utilization rate.

13. The file access path selection apparatus of claim 12, wherein the client is configured to, when the bandwidth utilization rate for the first network address is lowest, set the shortest path as the access path, and, when a bandwidth utilization rate for any one of the multiple candidate network addresses is lowest, set a secondary path that uses the one candidate network address as the access path.

14. The file access path selection apparatus of claim 11, wherein the client is configured to, when the file access pattern indicates a random-access pattern, set the shortest path as the access path.

15. The file access path selection apparatus of claim 13, wherein:
the layout information includes a data server ID of the object data server that corresponds to location coordinates of the object data server on the torus network, and
the client is configured to periodically acquire, from the management server, data server information corresponding to at least one of multiple network addresses that are allocated to the object data server depending on a structure of the torus network based on the data server ID, and bandwidth utilization rates for the multiple network addresses at a preset interval.

16. The file access path selection apparatus of claim 15, wherein the client is configured to select any one data server, which is located on the secondary path and corresponds to a first plane in the structure of the torus network, from among the multiple data servers, as a relay server, calculate and acquire location coordinates of the relay server based on the location coordinates of the object data server, and route the access path to include the location coordinates of the relay server.

17. The file access path selection apparatus of claim 12, wherein the first network address corresponds to a front network address allocated to a forward direction of the object data server.

18. The file access path selection apparatus of claim 12, wherein the client is configured to, when selecting of the access path is completed and an input/output processing request for the object file is received from the client, determine whether target data server information included in the input/output processing request matches the object data server.

19. The file access path selection apparatus of claim 18, wherein the client is configured to, if the target data server information does not match the object data server, re-route the access path so that the client is capable of connecting to a target data server matching the target data server information.

20. The file access path selection apparatus of claim 18, wherein the client is configured to, if it is determined that the target data server information matches the object data server, update a bandwidth utilization rate for a network address corresponding to the access path depending on an amount of bandwidth used in response to the input/output processing request.
